(19) United States
(12) Patent Application Publication
(10) Pub. No.: US 2006/0231043 A1
(43) Pub. Date: Oct. 19, 2006

(54) Pet waste cleanup kit

(76) Inventor: Deborah Ann Galdo, Glenmoore, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/108,986

(22) Filed: Apr. 19, 2005

(51) Int. Cl. A01K 27/00

(52) U.S. Cl. 119/796

(57) ABSTRACT

A pet waste cleanup kit for the collection and transport of animal fecal matter, comprises a pouch having at least a first compartment and a second compartment. A container is provided and is sized and shaped to fit within at least one of the compartments. The container has a first opening. A plurality of disposal bags are provided and are capable of being stored within the container. The disposal bags are adapted to be dispensed one at a time from the container through the first opening. A plurality of towelettes are provided and are capable of being stored within the container. The towelettes are adapted to be dispensed one at a time from the container through the first opening. The first opening is sized and shaped to receive both a disposal bag and a towelette and to allow the disposal bag and towelette to be dispensed concurrently.

### FIELD OF THE INVENTION

The invention relates generally to animal waste collection and particularly to kits used to facilitate cleanup and transport of pet waste produced by a dog while the dog is being walked.

### BACKGROUND OF THE INVENTION

It is known in the prior art to provide kits to facilitate collection and transport of animal fecal matter. Many pet owners, and in particular dog owners, are faced with the generally unpleasant task of cleaning up fecal deposits made by their pets while the pet is being walked. Various kits to facilitate the task of collecting and transporting pet waste matter are known. For example, U.S. Pat. No. 6,257,473 (Ringelstetter) discloses a pouch including a chamber for holding plastic bags containing retrieved pet waste. The pouch further includes side pockets and an interior pocket adapted to hold a supply of plastic litter bags. Furthermore, U.S. Pat. No. 6,273,481 (Columbo et al.) discloses a canine pet waste recovery and disposal kit comprising a sealed package containing a flexible bag having an absorbent towel and a pre-moistened towelette disposed therein. While these kits are functional, a need nonetheless exists for a more compact and convenient pet waste clean-up kit.

### SUMMARY OF THE INVENTION

The kit of this invention is a pet waste cleanup kit for the collection and transport of animal fecal matter. The kit comprises a pouch having at least a first compartment and a second compartment. A container is provided and is sized and shaped to fit within at least one of the compartments. The container has a first opening. A plurality of disposal bags are provided and are capable of being stored within the container. The disposal bags are adapted to be dispensed one, and no more than one, at a time from the container through the first opening. A plurality of towelettes are provided and are capable of being stored within the container. The towelettes are adapted to be dispensed one, and no more than one, at a time from the container through the first opening. The first opening is sized and shaped to receive both a disposal bag and a towelette and to allow the disposal bag and towelette to be dispensed concurrently.

In another aspect, the invention is a pet waste cleanup kit for the collection and transport of animal fecal matter. The kit comprises a pouch having at least a first compartment and a second compartment. A container is provided and is sized and shaped to fit within at least one of the compartments. The container has at least first and second openings. A plurality of disposal bags are provided and are capable of being stored within the container. The bags are adapted to be dispensed one, and no more than one, at a time from the container through the first opening. A plurality of towelettes are provided and are capable of being stored within the container. The towelettes are adapted to be dispensed one, and no more than one, at a time from the container through the second opening. The pet waste cleanup kit may further comprise a plurality of bag ties, and the container may further include a third opening, wherein the bag ties are dispensed one, and no more than one, at a time through the third opening.

The foregoing and other features of the invention and advantages of the present invention will become more apparent in light of the following detailed description of the preferred embodiments, as illustrated in the accompanying drawings. As will be realized, the invention is capable of modifications in various respects, all without departing from the invention. Accordingly, the drawings and the description are to be regarded as illustrative in nature, and not as restrictive.

### BRIEF DESCRIPTION OF THE DRAWINGS

For the purpose of illustrating the invention, there is shown in the drawings forms of the invention which are presently preferred; it being understood, however, that this invention is not limited to the precise arrangements and instrumentalities shown. In the drawings:

FIG. 1 is a perspective view of a pet waste cleanup kit in accordance with the present invention having a first preferred embodiment of a pouch shown releasably connected to a retractable pet leash.

FIG. 2 is a perspective view of the pet waste cleanup kit of FIG. 1 illustrating a pouch closure flap and a compartment closure flap, each shown in an open position.

FIG. 3 is a perspective view of a first embodiment of a cleanup supplies container of the pet waste cleanup kit of FIG. 1.

FIG. 4 is a perspective view of a second embodiment of a cleanup supplies container of the pet waste cleanup kit of FIG. 1.

FIG. 5 is a perspective view of a third embodiment of a cleanup supplies container of the pet waste cleanup kit of FIG. 1.

FIG. 6 is a perspective view of a pet waste cleanup kit in accordance with the present invention having a second preferred embodiment of a pouch shown permanently attached to a fixed length pet leash.

### DETAILED DESCRIPTION OF THE DRAWINGS

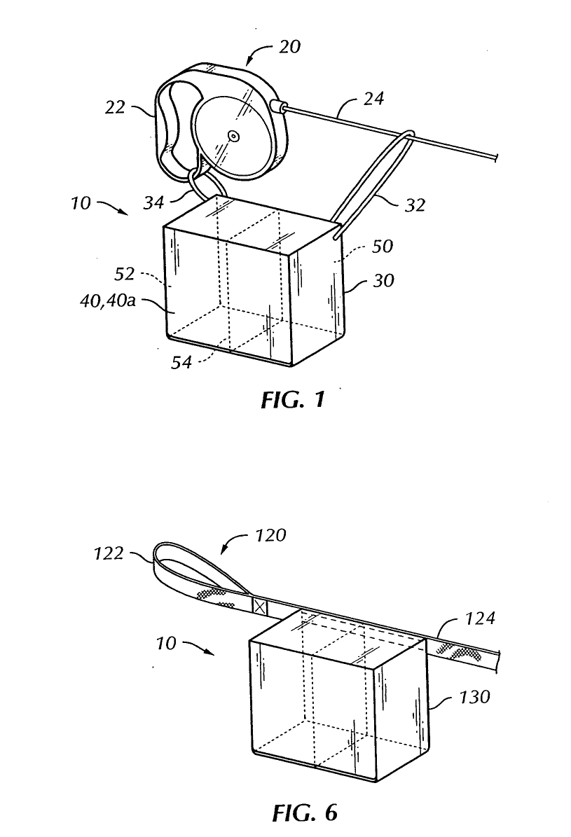

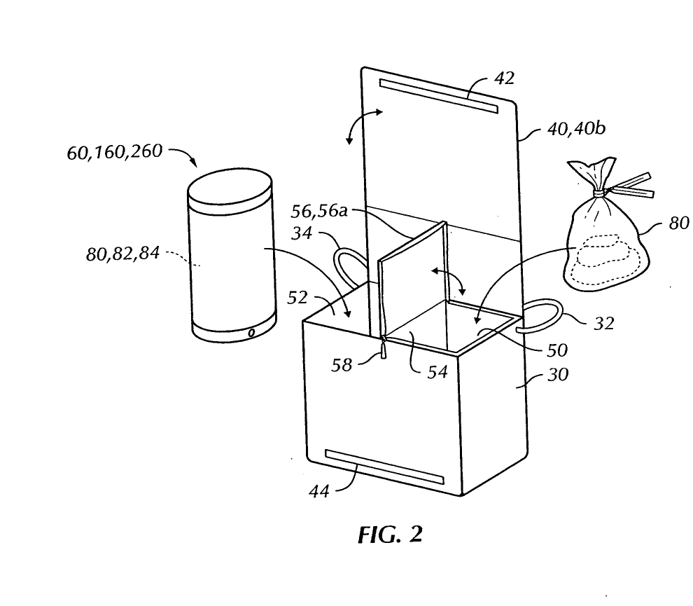

Referring to the drawings, wherein like numerals are used to indicate like elements throughout, there is shown in FIGS. 1-6 a pet waste cleanup kit 10 for the collection and transport of animal fecal matter. The kit 10 is preferably used in combination with a leash. The kit 10 comprises a pouch which is either releasably attachable to a leash or fixedly attached to a leash. With particular reference to FIG. 1, a first embodiment pouch 30 is releasably attachable to a leash 20, preferably a conventional retractable leash. With particular reference to FIG. 6, a second embodiment pouch 130 is fixedly attached to a fixed-length leash 120. Both first and second embodiment pouches 30, 130 have at least a first compartment 50 and a second compartment 52 separated by a divider 54. The kit 10 further comprises a container used to store a plurality of disposal bags 80 and a plurality of towelettes 82. With particular reference to FIGS. 2-5, first, second, and third embodiments 60, 160, and 260 of the container, respectively, are each sized and shaped to fit within the second compartment 52.

Referring again to FIG. 1, the first embodiment pouch 30 is releasably attachable to leash 20 by a first connector 32 and a second connector 34. The first and second connectors 32, 34 are conventional, and various types of connectors could be used, including mating hook and pile (for example, the hook and pile material sold under the tradename VELCRO®) straps or straps provided with mating snap button and receptacle base members. Preferably, second connector 34 attaches to a handle 22 of leash 20. First connector 32 could also be a continuous loop fixedly attached to the pouch 30, such that a cord 24 of the leash 20 could be threaded through the loop.

With particular reference now to FIG. 2, the pouch 30 is preferably provided with a closure, such as flap closure 40, to secure the contents within the first and second compartments 50 and 52. The flap closure 40 is movable between a closed position 40a and an open position 40b. Preferably, the flap closure 40 is provided with a first portion 42 of a hook and pile closure, while the mating surface of the pouch 30 is provided with a second portion 44 of the hook and pile closure, such that when the flap closure 40 is in the closed position 40a, the first and second portions 42, 44 of the hook and pile closure cooperate to hold the flap closure 40 in the closed position 40a.

Additionally, the first compartment 50 may be provided with a first compartment closure 56. The first compartment 50 is intended to receive used disposal bags 80 containing animal fecal matter, and the first compartment closure 56 is preferably provided to minimize odors emanating from the first compartment 50. The first compartment closure 56 is movable between an open position 56a and a closed position (not illustrated). Preferably, the first compartment closure 56 is held in the closed position by a zipper 58, although other types of closures (such as a snap button or hook and pile closure) could be provided.

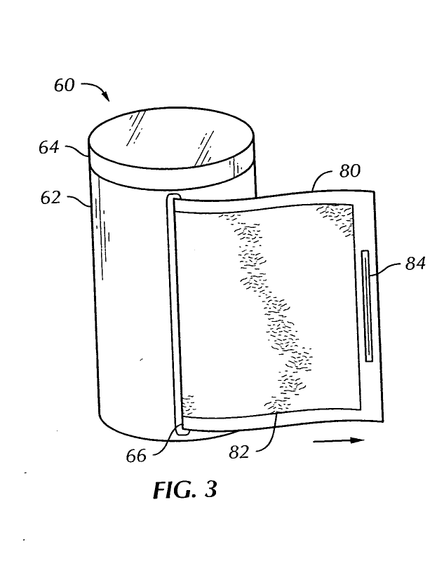

With reference now to FIG. 3, the first embodiment 60 of the container is generally shaped as a circular cylinder. Other shapes are possible. The container 60 has an exterior wall 62 defining an interior volume and a removable endcap 64. By removing the endcap 64, a roll of the plurality of disposal bags 80 may be installed within the container 60. The container 60 is provided with a first opening 66 through which the disposal bags 80 are dispensed.

By providing the disposal bags 80 in roll form, the bags 80 are dispensed sequentially, such that one bag, and no more than one bag, passes at a time through the first opening 66. The plurality of towelettes 82 are also dispensed through the first opening 66, sequentially, such that one towelette, and no more than one towelette, passes at a time through the first opening 66. Preferably, a towelette 82 is stored inside each bag 80, along with a bag tie 84. Alternatively, the towelette 82 can be rolled in a nested arrangement, with the towelettes 82 adjacent to the disposal bags 80, such that as one disposal bag 80 is unrolled, a towelette 82 is also unrolled. If rolled together with each other as described, each towelette 82 and disposal bag 80 can be releaseably attached together, for example with a glue or similar tacky substance. The bag tie 84 can also be similarly releasably attached to the disposal bag 80. As yet another alternative, the disposal bags 80 and towelettes 82 can be nested together in a manner similar to the manner in which facial tissues are nested together in a container allowing a first tissue to pull a subsequent second tissue partially though a container opening as the first tissue is pulled completely though the opening. That is, a first bag 80 and a towelette 82 set can be arranged to pull a second bag/towelette set partially through the opening 66 as the first bag/towelette is pulled completely through the opening 66.

The first opening 66 is illustrated to be in the form of an elongated slot, but the first opening 66 can be provided in other shapes and configurations. The first opening 66 is sized and shaped to receive both a disposal bag 80 and a towelette 82, allowing the bag 80 and towelette 82 to pass through the opening 66 simultaneously, thus allowing the bag 80 and towelette 82 to be dispensed concurrently.

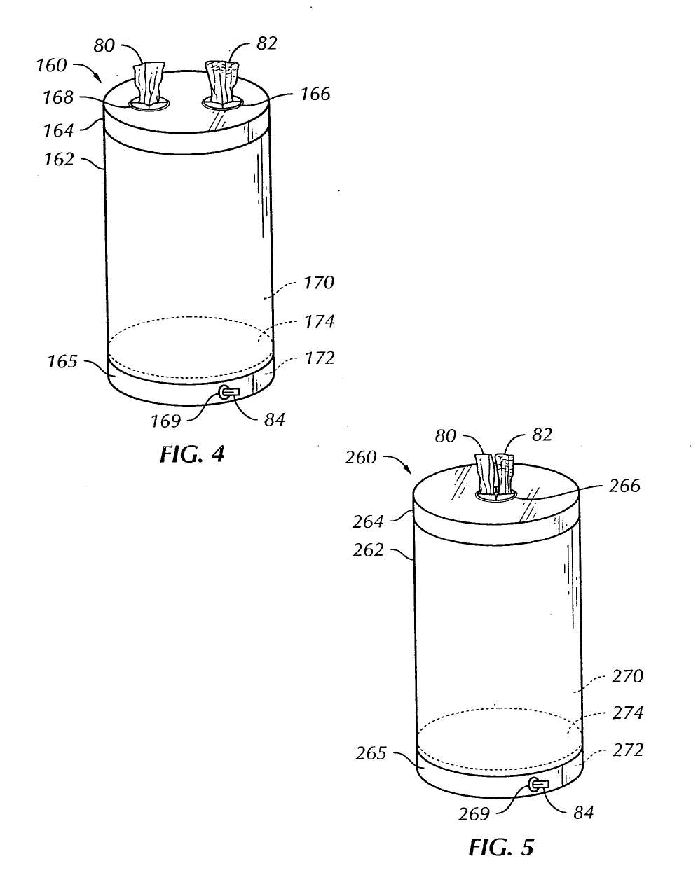

With reference now to FIG. 4, the second embodiment 160 of the container is also illustrated to be shaped generally as a circular cylinder. The second embodiment container 160 has an outer wall 162 forming a first volume 170. A removable endcap 164 is provided, allowing access to the first volume 170. The endcap 164 is provided with first and second openings 166, 168, respectively. The plurality of disposal bags 80 and plurality of towelettes 82 are stored within the first volume 170, and are dispensed sequentially, one, and no more than one, at a time through the openings 168, 166, respectively. Preferably, the plurality of disposal bags 80 are rolled together to form a first roll, and the plurality of towelettes 82 are rolled together to form a second roll.

Preferably, the second embodiment container 160 is further provided with a second removable endcap 165 and an intermediate endwall 174. The endcap 165 is attachable to the container 160 to define a second volume 172 separated from the first volume 170 by the endwall 174. The plurality of bag ties 84 may be stored in the second volume 172. Preferably, a third opening 169 is provided in the endcap 165. The bag ties 84 may be dispensed one at a time through the third opening 169. Preferably, the bag ties 84 are formed as a roll.

With reference now to FIG. 5, the third embodiment 260 of the container differs from the second embodiment container 160 in that only a first opening 266 is provided, rather than first and second openings 166, 168. Thus, both the disposal bag 80 and the towelette 82 are dispensed through the third embodiment first opening 266, rather than being dispensed through separate openings 166, 168 as in the second embodiment container 160. The third embodiment container 260 is otherwise similar to the second embodiment container 160, and elements of the third embodiment container 260 are numbered similarly to corresponding elements of the second embodiment container 160, except that the reference numbers are incremented by 100 between the second and third embodiments 160, 260. Except as noted, the description of corresponding elements of the second embodiment container 160 apply to the third embodiment container 260 elements.

With reference now to FIG. 6, the second embodiment pouch 130 is fixedly attached to the leash 120. The leash 120 includes a handle 122 and a cord 124. The second embodiment pouch 130 is preferably sewn or otherwise permanently attached to the cord 124. The second embodiment pouch 130 is otherwise similar to the first embodiment pouch 30, and the discussion above applies to the second embodiment pouch 130.

The materials of the components of the pet waste cleanup kit 10 are conventional, for example nylon blend fabrics can be used to fabricate the pouch 30 or 130 and polymeric materials, such as polypropylene, can be used to fabricate the container 60, 160, or 260. Conventional fabrication techniques, such as sewing for the pouch 30 or 130 and injection molding for the container 60, 160, or 260, can be used to fabricate the kit 10 components. Preferably, the pouches 30 and 130 are washable.

In use, the user will attach the leash 20 or 120 to the pet to be walked. If the pet deposits fecal matter in the course of the walk, the user will proceed to open the closure flap 40, and remove the container 60, 160 or 260 from the second compartment 52. The user will then dispense a disposal bag 80 and towelette 82 and preferably a bag tie 84 from the container 60, 160, or 260. After the fecal matter has been placed in the disposal bag 80, the user can use the towelette to clean the user's hands, and the used towelette can then also be placed within the disposal bag 80. The bag is preferably tied closed with the bag tie 84, and the used bag and towelette are then placed in the first compartment 50 for transport to the nearest waste receptacle.

A highly compact and convenient pet waste cleanup kit is thus provided.

Although the invention has been described and illustrated with respect to the exemplary embodiments thereof, it should be understood by those skilled in the art that the foregoing and various other changes, omissions and additions can be made therein and thereto, without parting from the spirit and scope of the present invention. Accordingly, reference should be made to the appended claims, rather than to the foregoing specification, as indicating the scope of the invention.

What is claimed is:

1. A pet waste cleanup kit for the collection and transport of animal fecal matter, comprising:
a pouch having at least a first compartment and a second compartment;
a container sized and shaped to fit within at least one of the compartments and having a first opening;
a plurality of disposal bags capable of being stored within the container and adapted to be dispensed one, and no more than one, at a time from the container through the first opening, and
a plurality of towelettes capable of being stored within the container and adapted to be dispensed one, and no more than one, at a time from the container through the first opening,
wherein the first opening is sized and shaped to receive both a disposal bag and a towelette and to allow the disposal bag and towelette to be dispensed concurrently.

2. The pet waste cleanup kit of claim 1, wherein the plurality of disposal bags and plurality of towelettes are rolled together to form a roll.

3. The pet waste cleanup kit of claim 1, wherein the plurality of disposal bags are rolled together to form a first roll and the plurality of towelettes are rolled together to form a second roll.

4. The pet waste cleanup kit of claim 1 further comprising a plurality of bag ties.

5. The pet waste cleanup kit of claim 4, the container further having a second opening, wherein the plurality of bag ties are adapted to be dispensed one, and no more than one, at a time through the second opening.

6. The pet waste cleanup kit of claim 5, wherein the plurality of bag ties are formed in a roll.

7. The pet waste cleanup kit of claim 5, wherein the container has a first volume for storage of the disposal bags and towelettes and a separate second volume for storage of the bag ties.

8. The pet waste cleanup kit of claim 1 wherein each of the plurality of towelettes is stored within one of the plurality of disposal bags.

9. The pet waste cleanup kit of claim 1 in combination with a pet leash, wherein the pouch is fixedly attached to the leash.

10. The pet waste cleanup kit of claim 1 in combination with a pet leash, wherein the pouch includes connectors allowing the pouch to be releasably attached to the pet leash.

11. The pet waste cleanup kit of claim 1 wherein the first opening is shaped as an elongated slot.

12. A pet waste cleanup kit for the collection and transport of animal fecal matter, comprising:
a pouch having at least a first compartment and a second compartment;
a container sized and shaped to fit within at least one of the compartments and having at least first and second openings;
a plurality of disposal bags capable of being stored within the container and adapted to be dispensed one, and no more than one, at a time from the container through the first opening, and
a plurality of towelettes capable of being stored within the container and adapted to be dispensed one, and no more than one, at a time from the container through the second opening.

13. The pet waste cleanup kit of claim 12 further comprising a plurality of bag ties, and the container further having a third opening, wherein the bag ties are adapted to be dispensed one, and no more than one, at a time through the third opening.
